(19) United States
(12) Patent Application Publication
(10) Pub. No.: US 2005/0182971 A1
(43) Pub. Date: Aug. 18, 2005

(54) Multi-purpose user authentication device

(76) Inventors: Peng T. Ong, Singapore (SG); Chua Teck Joo, Singapore (SG); Chin Kar Vui, Singapore (SG)

Correspondence Address: PERKINS COIE LLP, P.O. BOX 2168, MENLO PARK, CA, 94026, US

(21) Appl. No.: 10/777,626

(22) Filed: Feb. 12, 2004

(51) Int. Cl. H04L 9/00

(52) U.S. Cl. 713/202; 726/8

(57) ABSTRACT

A multi-purpose user authentication card that combines the functions of one-time passcode generator, storage components and smart card components in a single compact device. A microprocessor generates the one-time passcode, which is displayed on a screen for 30-60 seconds. A smart card performs basic encryption and decryption to allow the user to gain access to a protected external resource. An independent, rechargeable power source allows the card to switch between an active mode, a standby mode and an off mode.

### FIELD OF THE INVENTION

The present invention relates to a security device for computer systems, and, more particularly, to a device for the storage of information relating to user authentication, such private keys, for performing computations and cryptographic operations, and for generating a one-time passcode.

### BACKGROUND OF THE INVENTION

Electronic technology field has long been concerned with user authentication and verification for allowing a user access to various fields, from health clubs to credit card information, from offices to mainframe computers. A basic authentication system is used when a consumer uses a credit card for purchases. This familiar type of authentication uses a magnetic-stripe memory card, with the mag-stripe storing information about the card user and the user's account. A sales clerk swipes the card through a card reader, which extracts the card data from the magnetic stripe and transmits the data over a secured network to the card issuer. If the issuer confirms that the purchase is authorized the sales clerk completes the transaction. This process takes time, in the order of several seconds.

Development in technology led to creation of alternative authentication systems, which use passwords, personal identification numbers (PINs) pass codes, and the like. Attempts have been made to create a single smart card to hold the user data. This technology involves the downloading of information from a smart card issuer and does not allow a consumer to control the contents of the smart card, to add or modify information.

Some manufactures sell Universal Serial Bus (USB) compatible storage devices. Still other manufacturers one time passcode or password systems. Each of these types of devices addresses one aspect of digital identity management. For example, the Aladdin eToken provides a mechanism for authentication. RSA's SecurID provides a onetime pass code generator on a small device with an LCD (liquid crystal display) screen. Transcend and other companies provide mass storage on USB compatible devices.

However, in order to integrate these aspects of identity management, it would be advantageous to devise a method and apparatus for consolidating the functionality of the known digital authentication systems in a single, small, convenient to use device.

### SUMMARY OF THE INVENTION

It is, therefore, an object of the present invention to provide a user authentication device that is compatible with USB storage devices.

It is another object of the present invention to provide a user authentication device that can generate a one-time passcode.

It is a further object of the present invention to provide a user authentication device that is capable of storing user credentials and interfacing with external storage devices.

It is still a further object of the present invention to provide a user authentication device that is capable of functioning as a smart card.

These and other objects of the present invention are achieved through a provision of a multi-purpose authentication device that combines the functions of a one-time passcode generator, a smart card and storage of user credentials. The device is an integrated circuit that comprises a microprocessor coupled to a control button, a non-volatile RAM, a communications controller and a bus for interfacing an external device, such as for instance a CPU. The microprocessor is powered by an internal battery that allows generation of a one-time passcode even when the authentication device is not connected to any external power source.

A non-volatile storage stores user credentials and interfaces with external hardware and software through a controller connected to the bus. The smart card performs the basic functions of encryption, decryption, signing, generating asymmetric cryptographic key pairs, and for generating symmetric cryptographic keys. The smart card has its own programmable memory, such as EEPROM.

A display screen allows displaying of the passcode generated by the microprocessor for a pre-determined period of time, for instance 30-60 seconds, after which time the screen is de-activated to conserve the power of the energy source. The processor may also be programmed to remain in a standby mode or for maintaining the passcode generation system in an “off” mode. The results of the passcode computation system are displayed on the screen upon demand by pressing a control button operationally connected to the microprocessor.

### BRIEF DESCRIPTION OF THE DRAWINGS

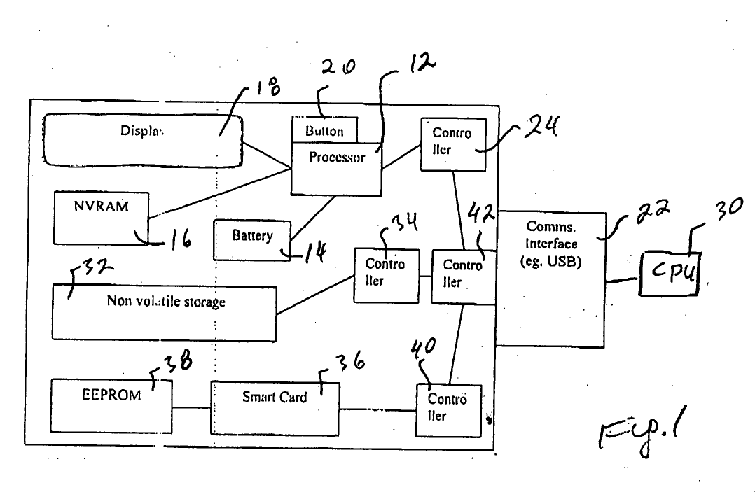

Reference will now be made to the drawings, wherein like parts are designated by like numerals, and wherein FIG. 1 illustrates a simplified block diagram of the electronic device in accordance with the present invention.

### DETAILED DESCRIPTION OF THE PREFERRED EMBODIMENT

Turning now to the drawing in more detail, the user authentication device of the present invention is designated by numeral 10. The device 10 is processor-based system with a processor 12 operatively coupled to various memory devices. The processor 12, which can be a microprocessor/micro controller, is powered by a battery 14 and is coupled to a main memory 16, such as a random access memory (RAM) or other dynamic storage device.

In the preferred embodiment the memory 16 is non-volatile memory random-access memory device (NVRAM) 16. NVRAM 16 allows the device 10 to retain the stored data when power is turned off. NVRAM 16 stores information and instructions to be executed by the processor 12. The memory 16 may also be used for storing temporary variables or other intermediate information during execution of instructions to be executed by the processor 12.

The NVRAM 16 may be an external chip or an integrated circuit (IC), or it may form a part of the microprocessor/micro controller 12. It is envisioned that the capacity of the memory 16 may range from several hundred bytes to several kilobytes.

The device 10 further comprises a video display screen 18 coupled to the microprocessor 12 and a control button 20. When the button 20 is depressed, the processor 12 is activated to perform a computation to generate a one-time passcode. Such computation may also be performed in response to a signal sent through a communications interface 22 from a central processing unit (CPU) 30. The program to perform these computations and provide other functionality is stored internally in the microprocessor 12 or in the non-volatile memory 16.

The microprocessor 12 is further coupled to a communication controller 24, which includes USB interface engine for operational connection with the communications interface 22. The communication controller 24 comprises a communication control mechanism for controlling communications with a central processing unit (CPU) 30 via bus 22, the controller 24 and the processor 12.

The controller 24 allows the user to enter instructions for the computations performed by the processor 12. The communication controller 24 has the function for sending data to and receiving data from the CPU 30, which may be a portable electronic device.

The battery 14 may be a regular or a rechargeable battery. A rechargeable battery is charged every time the device 10 is connected through the communications port 22 to another electronic device or the CPU 30, which can provide the necessary power. A non-rechargeable battery can be of replaceable or non-replaceable nature. A non-rechargeable, non-replaceable battery may be used of the device 10 is a one-time, disposable device, which will be discarded after a few months or years of use. A non-rechargeable, replaceable battery can replaced in device 10 whenever the original battery runs out of energy.

The device 10 further comprises a secondary storage device 32, which can be a flash memory. The non-volatile storage 32 allows storage of user credentials and other important identification data. The storage 32 is operationally connected to a user credentials controller 34, which provides an interface to external hardware, such as the CPU 30 and software to access the storage device 32.

The storage 32 may be also used to transport data from one computer to another and to store software and programs. The software used by the device 10 allows the user's credentials to be revoked at any time by erasing the credentials from the storage 32. Alternatively, the user's identifying credentials may be one-time use only and designed to be modified with every use.

It is envisioned that the management software may be programmed to prompt the user to change the initial password and other authentication data through the server CPU or by displaying the prompt on the display 18 if the authentication device 10 is to be used more than one time. It is also envisioned that the controller 34 may be programmed to recognize the expiration date of the assigned user's credentials and prevent the current user from encrypting and decrypting data using the device 10.

In the preferred embodiment, the storage 32 has a relative large storage space, in the order of 32-64 MB. The large capacity of the storage 32 allows loading of the necessary software and device drivers to facilitate operations with the CPU 30. By plugging the device 10 into a USB port or serial port of the CPU 30, the user can load all the software and device drivers into the CPU 30.

The device 10 further comprises a smart card 36 and its associated persistent reader/write memory such as EEPROM (Electrically Erasable Programmable ROM) 38 and a smart card controller 40. The EEPROM 38 may be inside the smart card 36 and not an external device. The smart card 36 forms the core of the cryptographic engine in the device 10. It is used to generate asymmetric cryptographic key pairs, symmetric cryptographic keys, to perform encryption, decryption and signing. The controllers 24, 34 and 40 are operationally connected to a unified controller 42, which is directly coupled to the bus 22.

A multi-bit bus (not shown) connects the components to the interface 22. The storage of EEPROM 38 may be used to store cryptographic keys to facilitate authentication and secure data exchange. For instance, the smart card 36 may store data exchange keys; or store one or more certificates authenticating a particular user. These certificates might contain a card ID, user ID, files with programmed values for a particular transaction, such as bank assets, travel awards, hotel bonus points, medication information, and a multitude of other necessary data.

The smart card 36 and its associated EEPROM maintain information to which the user wishes to control access. The controller 40 may be programmed to only retrieve information upon authentication by the user and/or other authorized entities. One technique for authenticating the user is to require the user to enter a passcode generated by the microprocessor 12. The passcode is entered through a card reader (not shown) or CPU 30. The CPU 30 compares the entered passcode to a passcode stored in EEPROM 38, and authenticates the user if the entered and stored passcodes match.

The EEPROM 38 may also hold authentication and authorization tables with lists of identities that can be authenticated, such as people, entities, agencies, code, hardware, and so on. The authorization tables may provide authorization as a Boolean expression of identities that can be authenticated listed in the authentication tables. The smart card 36 maintains the authentication vectors in EEPROM 38. The authentication vectors may track the identities of the currently authenticated by the card.

The smart card 36 is designed to keep track of the user's identity, which does not have to be aliased or reused. The data access policies can be expressed directly in terms of these identities or be independent of other features of the card, such as data location. To successfully authenticate the user's access, the smart card decrypts the user's credentials, such as correct user ID, password, passcode, correct smart card. The authentication data is compared with that encrypted in the user's credentials. If there is a match, the passcode, password, etc. is accepted and access is granted. If incorrect user ID, password, or passcode is entered, the device 10 will not decrypt the credentials file.

The multi-purpose authentication device 10 can be used in many different ways and for many diverse environments. The device 10 may be used to allow access to the CPU, to protected premises, to rent a movie, to withdraw money from a bank, to buy goods and services from vendors, etc. In each environment, the device 10 performs various authentication procedures to verify the authenticity of the participating identity. The authentication procedures may be performed using conventional techniques. For instance, the device 10 may verify the user by requesting a PIN and comparing the PIN entered by the user with the passcode stored in the memory 16 and 38.

The device 10 may also be used to store user identity information such as private keys, usernames, and security passwords. It can be used to identify a user to a server using a challenge response protocol or some similar protocol using cryptographic operations performed in the smart card. User information, such as credentials, passwords, etc. may be stored on the smart card, or on the storage device in an encrypted form.

The one time passcode generator may operate as a stand-alone module without communicating with the smart card components or the storage device. It is used for generating a one-time passcode for user authentication. The one-time passcode components are functional even when the device 10 is not connected to any external device through the communications interface 22 since it is powered by an independent power source 14, which may be a rechargeable battery. The one-time passcode may also be queried and updated through a software interface when connected to external hardware (such as CPU 30) through the communications interface.

The CPU 30 may be conventionally coupled to the device 10 for for receiving command-line instructions from and displaying information to a computer user. Conventionally, CPU 30 may include an input device such as a keyboard, and may include a cursor control such as a mouse, a trackball, or cursor direction keys for communicating direction information and command selections to processor 12.

The multi-purpose device 10 is relatively small in size and may be carried in the user's pocket, or wallet, or on a key chain. The button 20 to activate the one-time passcode generator may be formed flush with the exterior surface of the device 10 to prevent accidental activation of the one-time passcode system. To conserve the battery power when the device 10 is not connected to an external power source, the one-time passcode system could be programmed to operate with a “standby” mode or “off” function. It may be activated only when the button 20 is pressed.

Pressing of the button 20 causes the processor 12 generate a new one-time passcode, display it on the screen 18 for a pre-determined short period of time (30-60 seconds) and then shut off to conserve power.

Many changes and modifications may be made in the design of the present invention without departing from the spirit thereof. I, therefore, pray that my rights to the present invention be limited only by the scope of the appended claims.

1. A multi-purpose authentication device, comprising:
a main memory;
a processor coupled to access the main memory; and
an access code generating means located in the processor for generating a one-time access code associated with a single user's identity, for correlating authentication protocols with the access codes stored in the memory and for communicating the authentication of the user's access to an external protected resource.
an independent power source operationally connected to the processor.
a communications controller for interfacing to an external processing device.

2. The device of claim 1, further comprising a smart card coupled to the processor through a controller for generating cryptographic keys, for performing encryption, decryption and signing of the single user for gaining access to the external protected resource.

3. The device of claim 2, wherein said smart card is provided with a programmable ROM.

4. The device of claim 3, wherein said programmable ROM is EEPROM.

5. The device of claim 3, further comprising an auxiliary memory for storing user credentials and a controller for interfacing with external hardware, the main memory, the smart card and the processor.

6. The device of claim 1, wherein said processor controls operation of the device between an active mode, a standby mode and an “off” mode.

7. The device of claim 1, further comprising a display screen associated with the processor.

8. The device of claim 7, wherein said processor controls operation of the display screen for displaying a passcode for a predetermined period of time and for de-activating the display screen upon passage of the predetermined period of time.

9. The device of claim 1, wherein said processor is operationally connected to a control button for activating the processor and generating the passcode upon demand.

10. The device of claim 1, wherein said communications controller uses a USB interface

11. The device of claim 1, wherein said independent power source is a rechargeable battery.

12. The device of claim 1, wherein said independent power source is a replaceable battery.

13. A multi-purpose authentication device, comprising:
a main memory;
a processor coupled to access the main memory;
an access code generating means located in the processor for generating a one-time access code associated with a single user's identity, for correlating authentication protocols with the access codes stored in the memory and for communicating the authentication of the user's access to an external protected resource;
a non-volatile storage memory coupled to a controller for providing an interface of the processor to the external protected resource; and
a smart card operationally connected to the controller for providing encryption and decryption functions and enabling identity management of the user.
an independent power source operationally connected to the processor
a communications controller for interfacing to an external processing device.

14. The device of claim 13, wherein said smart card is provided with a programmable ROM.

15. The device of claim 14, wherein said programmable ROM is EEPROM.

16. The device of claim 13, wherein said processor is operationally connected to a control button for activating the processor and displaying the one-time passcode upon demand.

17. The device of claim 13, wherein said power source being de-activated after a pre-determined period of time.

18. The device of claim 13, wherein said processor is coupled to a display screen for displaying the user's authentication code upon demand.

19. The device of claim 13, wherein said communications controller uses USB communications interface bus.

20. The device of claim 13, wherein said independent power source is a rechargeable battery.

21. The device of claim 13, wherein said independent power source is a replaceable battery.
